(19) United States
(12) Patent Application Publication
(10) Pub. No.: US 2024/0350888 A1
(43) Pub. Date: Oct. 24, 2024

(54) SYSTEMS AND METHODS FOR FOOTBALL BROADCASTING AND GAMEPLAY

(71) Applicant: Fox Sports Productions, LLC, Los Angeles, CA (US)

(72) Inventors: Michael Davies, Los Angeles, CA (US); David Eric Shanks, Los Angeles, CA (US); Zachary Fields, Woodland Hills, CA (US); Bradley Cheney, Green Village, NJ (US)

(21) Appl. No.: 18/760,529

(22) Filed: Jul. 1, 2024

Related U.S. Application Data
(63) Continuation of application No. 18/085,111, filed on Dec. 20, 2022.
(60) Provisional application No. 63/291,660, filed on Dec. 20, 2021.

(51) Int. Cl. A63B 71/06; A63B 43/00

(52) U.S. Cl. CPC A63B 71/0605; A63B 43/004; A63B 2071/0694; A63B 2220/89; A63B 2243/007

(57) ABSTRACT

Improvements regarding aspects of football are described, including with regard to tools and methods facilitating game and league play, as well as tools and methods for broadcast, including capture and presentation of broadcast for football.

### CROSS-REFERENCE TO RELATED APPLICATIONS

This application is a continuation of U.S. patent application Ser. No. 18/085,111, filed Dec. 20, 2022, which claims the benefit of U.S. Provisional Application No. 63/291,660, filed Dec. 20, 2021, the disclosure of which is incorporated herein by reference their entirety.

### FIELD

The present technology is generally related to football, including league play and broadcasting.

### BACKGROUND

The present disclosure describes various improvements regarding aspects of football, including with regard to tools and methods facilitating game and league play, as well as tools and methods for broadcast, including capture and presentation of broadcast for football.

### SUMMARY

The techniques of this disclosure generally relate to various improvements regarding aspects of football, including with regard to tools and methods facilitating game and league play, as well as tools and methods for broadcast, including capture and presentation of broadcast for football.

In one exemplary embodiment, systems and methods described herein remedy occluded action by taking advantage of highlighting of objects to show the location of the objects during such occluded action, e.g., to show the location or estimated location of a football during a tackle, where the ball might otherwise not be thoroughly shown on screen. The present disclosure recognizes that in exemplary aspects, the object(s)' location may be determined via computer tracking, over time; however, during occluded action, exclusive use of computer tracking may lead to inaccuracies without further use of location indicators.

Location indicators may include, e.g., global positioning satellite (GPS) technology or other location indicator chips (e.g., RFID, Active RFID, including transponders or beacons, other RF emitters), FM (or other wavelength) transmitters or any other location emitter devices (e.g., providing location within one or more frames of reference or to plural camera sources from different angles), etc.

Additionally, or in the alternative, plural detectors/receivers may be used above, around or below (e.g., buried or partially underneath the surface of) the venue (e.g., around a football field) to receive an easier (or the easiest) received location signal for the object. We also note that the located object may be other than a ball, e.g., a shoe, a helmet, an article of clothing, a club, a bat, a drone, etc. Additionally, plural detectors/receivers may, in concert, assist in more accurately determining the position of the emitted signal.

Further, the tracked object (e.g., ball) may include one or both of an emitter and a receiver. In exemplary embodiments, the ball may broadcast its location for one or more detectors/receivers and/or may receive signals when in close proximity to other signal broadcast points (e.g., line markers, such as goal line/end zone markers, sidelines, end lines (at any point around the field), goal posts, soccer posts (or other stationary objects), or any other points or lines of interest for the sport/venue), and signal a proximity alert, which may be based upon signal strength.

Further, such systems (including automatic processing of received and/or transmitted data) may determine whether an object (e.g., a ball, player, shoe, etc.) has crossed wholly or at least partially over one of those lines, markers, posts, etc., which may have relevance to rules of play. Additionally, such systems (including automatic processing of received and/or transmitted data) may determine whether an object (e.g., a ball, player, shoe, a particular player's shoe (or even the outside of one of a player's shoe), etc.) has crossed wholly or at least partially over one of those lines, markers, posts, etc., and re-entered the field, which may have relevance to rules of play.

Additionally, the present disclosure contemplates further boosting of signal, e.g., singly, intermittently or at all times, or during perceived (by processor or otherwise) low signal, such as via use of a boosted signal via exemplary extra antenna or extra power charge (such as via a battery) that may occur over a period (or one or more subsets of a period) of low signal in order to push the emitted signal through the occluded action to one or more detectors/receivers.

The object (e.g., a football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, alone or in combination with observed characteristics of the ball over a time period, can be used to further show aspects of that ball, e.g., showing rotation of the ball in the air, deflections, changes in rotations due to deflections, etc., via highlights or animation or otherwise.

In other exemplary embodiments, at least a nominal length of tape including plural LEDs are at least partially buried on a field, e.g., a football field on a line or other marker. The LEDs emit light detectable by one or more cameras or by a camera system, e.g., using infrared light detectable by infrared sensors on the one or more cameras. These lines, markers, positions, etc., may also include the emitters and/or detectors described above (and otherwise herein) to provide relative mapping, tracking, and/or visualization, etc. (manually or automatically via a processor) of positions between objects of interest (e.g., a ball, a particular player's shoe, etc.) and the stationary point or line of interest.

In other exemplary embodiments, one or more poles includes one or more laser sources to provide visual indication of position, measurement or interruption of a projected laser line. In one exemplary aspect, a yard measuring pole includes a laser therein, positioned perpendicular to the field, to provide a laser line measure for a ball on the field to indicate whether a first down has been achieved. The laser may be mounted via a level, gimbal or other sensor or device to provide the perpendicular laser line. Additionally, a system may include plural poles with lasers.

The laser(s) may be positioned such that the beam projects across the field to intersect a ball or other object should it be within the path, and/or to otherwise paint a laser image (in the human visible spectrum or outside of the visible spectrum but detectable by at least one sensor or camera) across the field (perpendicularly) to show the first down line (or other line of interest). Plural lasers may also be incorporated in a two-pole, connected or not connected, system similar to chains traditionally used, to project additional lines across the field. Additionally, a single pole may project a line parallel to the field (forward or backward) to show a measure of distance parallel to the field on the surface, as well (via a split signal from the same laser or from a different laser) as perpendicularly across the field for the first down line (or other line of interest).

In further exemplary aspects, a stationary pole, such as a field goal, may include at least one laser, to show whether a field goal does or does not qualify. Such laser(s) may be mounted at the inner boundary of the poles (e.g., for college football), and/or the exterior boundary of the poles (e.g., for professional football) and indicate a break should a portion of the ball intersect the laser line. This may additionally be highlighted on the broadcast or GUI/display, with or without the assistance of ball highlighting technology and/or sensors also described herein.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front perspective view of an exemplary GUI or display of football action, including occluded action using highlighting for occluded object(s);

FIG. 2 is a perspective view of a portion of a field, such as a football field, with at least partially buried LED tape emitting light, e.g., infrared light; a

FIG. 3 is a top elevation view of a pole (in this case, a sideline pole) integrating a laser therein; and

FIG. 4 is a front elevation view of a pole (in this case, a field goal) integrating a laser therein

### DETAILED DESCRIPTION

As we have noted, the present disclosure describes various improvements regarding aspects of football, including with regard to tools and methods facilitating game and league play, as well as tools and methods for broadcast, including capture and presentation of broadcast for football.

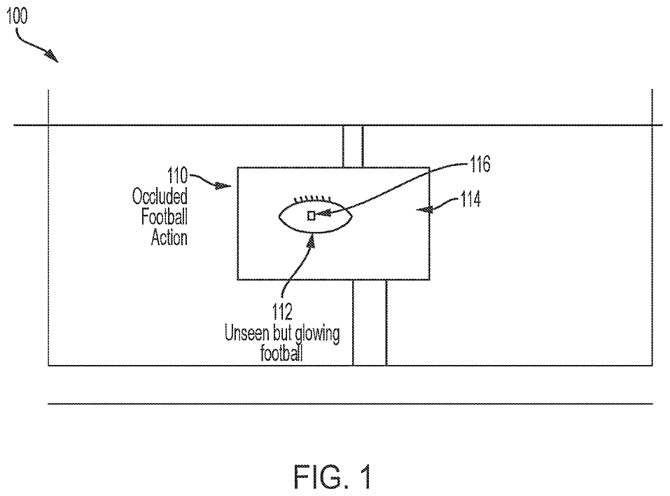

FIG. 1 illustrates generally at 100 a first exemplary embodiment, showing occluded action generally at 110, including showing an object/ball 112 on a broadcast image, GUI or screen 114. In one exemplary embodiment, systems and methods described herein remedy occluded action by taking advantage of highlighting of objects to show the location of the objects during such occluded action, e.g., to show the location or estimated location of a football during a tackle, where the ball might otherwise not be thoroughly shown on screen. In exemplary aspects, the object(s)′ location may be determined via computer tracking, over time, via location indicators, such as global positioning satellite (GPS) or other location chips (e.g., chip 116) or emitters (e.g., providing location within one or more frames of reference or to plural camera sources from different angles), etc.

The object (e.g., football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, or observed characteristics of the ball over a time period, can be used to further show aspects of that ball, e.g., showing rotation of the ball in the air, deflections, changes in rotations due to deflections, etc., via highlights or animation or otherwise.

The object/ball can be shown in moving video with the ball glowing, and can be shown in various angles or views, such as in an overhead view. Exemplary chips that could be used in the ball may provide robust information beyond location, such as rotation, acceleration, changes in acceleration, changes in pressure, etc.

We note that during occluded action, exclusive use of computer tracking may lead to inaccuracies without further use of location indicators. Location indicators may include, e.g., global positioning satellite (GPS) technology or other location indicator chips (e.g., RFID, Active RFID, including transponders or beacons, other RF emitters), FM (or other wavelength) transmitters or any other location emitter devices (e.g., providing location within one or more frames of reference or to plural camera sources from different angles), etc.

Additionally, or in the alternative, plural detectors/receivers may be used above, around or below (e.g., buried or partially underneath the surface of) the venue (e.g., around a football field) to receive an easier (or the easiest) received location signal for the object. We also note that the located object may be other than a ball, e.g., a shoe, a helmet, an article of clothing, a club, a bat, a drone, etc. Additionally, plural detectors/receivers may, in concert, assist in more accurately determining the position of the emitted signal.

Further, the tracked object (e.g., ball) may include one or both of an emitter and a receiver. In exemplary embodiments, the ball may broadcast its location for one or more detectors/receivers and/or may receive signals when in close proximity to other signal broadcast points (e.g., line markers, such as goal line/end zone markers, sidelines, end lines (at any point around the field), goal posts, soccer posts (or other stationary objects), or any other points or lines of interest for the sport/venue), and signal a proximity alert, which may be based upon signal strength.

Further, such systems (including automatic processing of received and/or transmitted data) may determine whether an object (e.g., a ball, player, shoe, etc.) has crossed wholly or at least partially over one of those lines, markers, posts, etc., which may have relevance to rules of play. Additionally, such systems (including automatic processing of received and/or transmitted data) may determine whether an object (e.g., a ball, player, shoe, a particular player's shoe (or even the outside of one of a player's shoe), etc.) has crossed wholly or at least partially over one of those lines, markers, posts, etc., and re-entered the field, which may have relevance to rules of play.

Additionally, the present disclosure contemplates further boosting of signal, e.g., singly, intermittently or at all times, or during perceived (by processor or otherwise) low signal, such as via use of a boosted signal via exemplary extra antenna or extra power charge (such as via a battery) that may occur over a period (or one or more subsets of a period) of low signal in order to push the emitted signal through the occluded action to one or more detectors/receivers.

The object (e.g., a football) could be shown on-screen or on a GUI/display as a glowing object or outline of an object, even e.g., under the occluding mass of plural players, as a location, e.g., relative to a first down or goal, or otherwise. In further exemplary embodiments, data from sensors within the ball, alone or in combination with observed characteristics of the ball over a time period, can be used to further show aspects of that ball, e.g., showing rotation of the ball in the air, deflections, changes in rotations due to deflections, etc., via highlights or animation or otherwise.

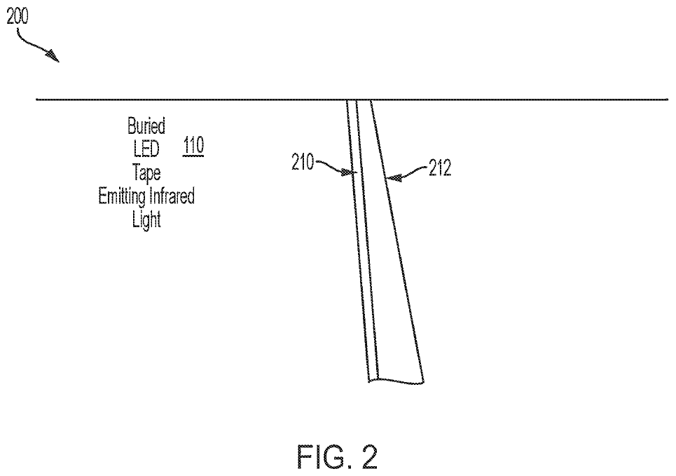

Referring now to FIG. 2 (and generally at 200), in other exemplary embodiments, at least a nominal length of tape 210 including plural LEDs are at least partially buried on a field, e.g., a football field on relative to a field line 212 or another marker. The LEDs emit light detectable by one or more cameras or by a camera system, e.g., using infrared light detectable by infrared sensors on the one or more cameras. The length can span the entire line (or marker), can be overlayed on the line or marker or can be positioned relative to the line or marker. Additionally, LEDs can be provided along the length, intermittently, at either end, or any other variations for marking/camera pickup purposes.

Additionally, the tape 210 described herein can be used with any other embodiments described herein, e.g., chipped football, display of the object/ball relative to the line, etc. (e.g., with an overlay of a glowing football crossing an infrared goal line). Additionally, though IR is described in aspects herein, other wavelengths are considered to be included in the scope of the invention. Additionally, radio frequency markers may be utilized in the alternative or in addition to the IR LEDs described herein.

These lines, markers, positions, etc., may also include the emitters and/or detectors described above (and otherwise herein) to provide relative mapping, tracking, and/or visualization, etc. (manually or automatically via a processor) of positions between objects of interest (e.g., a ball, a particular player's shoe, etc.) and the stationary point or line of interest.

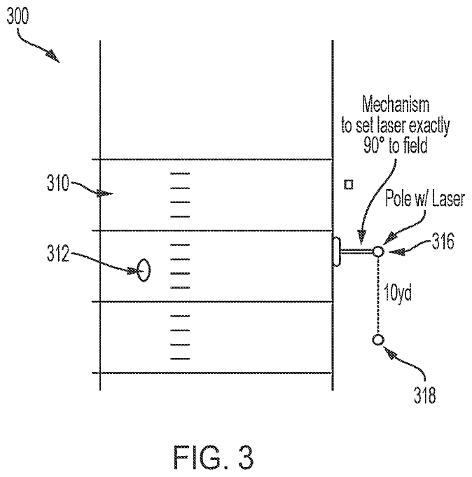

Referring now to FIG. 3, in other exemplary embodiments, one or more poles 316 includes one or more laser sources to provide visual indication of ball 312 position on a field 310, using a projected laser line 318, configured to terminate at a specific distance, e.g., 10 yards downfield. In such a way, the exemplary pole can eliminate inaccuracies of traditional first down chains and ensure accurate determination of measurements on the field. The laser may also be configured to project a line across the field to assist in visualizing or measuring ball location. Additionally, multiple poles, optionally linked, e.g., 10 yards apart, may be used with their own lasers to visualize or measure ball position. Further, ball sensor or tracking data may be used to further determine/ensure proper ball position and first down and/or goal determinations.

Accordingly, in exemplary aspects, a yard measuring pole includes a laser therein, positioned perpendicular to the field, to provide a laser line measure for a ball on the field to indicate whether a first down has been achieved. The laser may be mounted via a level, gimbal or other sensor or device to provide the perpendicular laser line. Additionally, such a system may include e.g., a locked in pole and/or robust base to ensure a 90-degree angle to the field. Software, laser aperture or mounting calibration equipment may provide fine adjustment/calibration to ensure perpendicular or other desired angle adjustment.

Additionally, a system may include plural poles with lasers. The laser(s) may be positioned such that the beam projects across the field to intersect a ball or other object should it be within the path, and/or to otherwise paint a laser image (in the human visible spectrum or outside of the visible spectrum but detectable by at least one sensor or camera) across the field (perpendicularly) to show the first down line (or other line of interest). Plural lasers may also be incorporated in a two-pole, connected or not connected, system similar to chains traditionally used, to project additional lines across the field. Additionally, a single pole may project a line parallel to the field (forward or backward) to show a measure of distance parallel to the field on the surface, as well (via a split signal from the same laser or from a different laser) as perpendicularly across the field for the first down line (or other line of interest).

In further exemplary embodiments, a referee or other official can press a button, e.g., on a belt, wrist or finger to light the one or more laser sources to show the measurement.

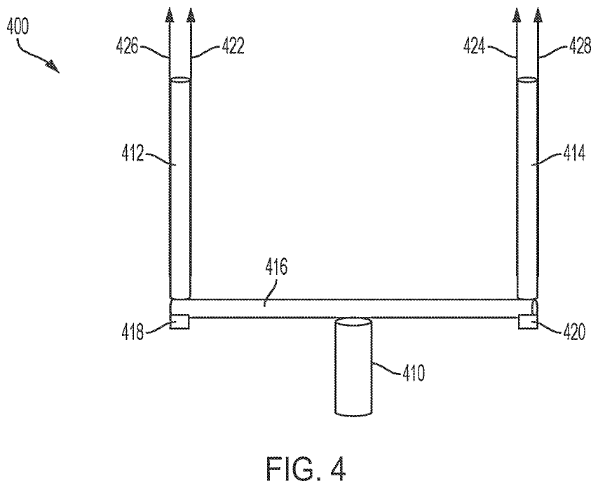

In further exemplary aspects, a stationary pole, such as a field goal, may include at least one laser, to show whether a field goal does or does not qualify. Reference is made to FIG. 4, with an exemplary field goal shown generally at 400. The exemplary field goal includes a base pole 410, left and right-side poles 412, 414 and a connector pole 416. At least one laser source (of any convenient wavelength, e.g., in the human visible spectrum or otherwise (but detectable by one or more of a sensor or camera/camera system)) is provided in or on the field goal. In the illustrated exemplary embodiment, a first laser source is provided on or in a portion of post 412; and a second laser source is positioned on or in a portion of post 420.

The projecting laser lines from such one or more sources may be mounted such that they project upwards from the inner boundary of the poles (e.g., for college football) (see lines 422, 424 bounding the interior of the goal posts), and/or the exterior boundary of the poles (e.g., for professional football) (see lines 426, 428 bounding the exterior of the goal posts) and indicate a break should a portion of the ball intersect the laser line. This may additionally be highlighted on the broadcast or GUI/display, with or without the assistance of ball highlighting technology and/or sensors also described herein to further confirm ball location relative to the laser line/field goal post.

Additionally, as has been mentioned above, the exemplary goal may include transmitters/emitters or receivers relative to tracked, moving object(s) of interest (e.g., a ball) to assist in determinations of a goal or to otherwise assist in locating such object(s) relative to the goal.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

What is claimed is:

1. A system for determining the location of the objects during broadcast play action, comprising:
a processor configured to track an object of interest on or around a field of play during broadcast play action utilizing ingested live play action from a plurality of witness cameras, wherein the processor triangulates the location of the object of interest;
a user interface configured to accept a remote operator's input to pinpoint the objects of interest, wherein the input is used alongside such triangulation to assist in pinpointing the object's location.

2. A system in accordance with claim 1, wherein the pinpointing of the object's location is accurate to within about 3 millimeters.

3. A system in accordance with claim 1, wherein a lidar scan is also utilized by the processor to assist with pinpointing the object's location.

4. A system in accordance with claim 3, wherein the pinpointing of the object's location is accurate to within about 3 millimeters.

5. A system in accordance with claim 4, wherein the object is a ball.

6. A system in accordance with claim 5, wherein the pinpointed location of the ball is relative to a first down line.

7. A system in accordance with claim 6, wherein the processor determines whether a football has crossed at least partially over a first down line to determine whether a first down has been achieved.

8. A system in accordance with claim 1, wherein the plural witness cameras comprise at least three witness cameras.

9. A system in accordance with claim 8, wherein the witness cameras are provided on both of either side of the field of play.

10. A system in accordance with claim 8, wherein the witness cameras comprise at least four cameras, with two on either side of the field of play.

11. A system in accordance with claim 1, further comprising a second user interface for a second remote operator, the second user input configured to provide animation for the broadcast related to movement, tracking or placement of a ball.

12. A system in accordance with claim 11, wherein the ball is shown on-screen or on a GUI as a glowing or outline of an object.
